(19) United States
(12) Patent Application Publication
(10) Pub. No.: US 2017/0263068 A1
(43) Pub. Date: Sep. 14, 2017

(54) METHOD FOR GENERATING COUNTING EVENTS AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Zongjian YANG, Beijing (CN)

(21) Appl. No.: 15/242,241

(22) Filed: Aug. 19, 2016

Related U.S. Application Data
(63) Continuation of application No. PCT/CN2016/088490, filed on Jul. 4, 2016.

(30) Foreign Application Priority Data
Mar. 14, 2016 (CN) 201610144976.5

(51) Int. Cl. G07C 13/00

(52) U.S. Cl. CPC G07C 13/00

(57) ABSTRACT

The present disclosure describes a method and an electronic device for generating counting events, wherein the method mainly includes: storing preset counting rules, counting options and counting topics in a counting database; acquiring a target counting event identification that includes a target counting rule identification, a target counting topic identification and a target counting option identification; acquiring the corresponding target counting rule, target counting topic and target counting option from the counting database according to the target counting event identification; and generating a target counting event.

### CROSS REFERENCE TO RELATED APPLICATIONS

This application is a continuation of International Application No. PCT/CN2016/088490, with an international filing date of Jul. 4, 2016, which is based upon and claims priority to Chinese Patent Application No. CN201610144976.5, filed with State Intellectual Property Office on Mar. 14, 2016 all the contents of which are incorporated herein by reference.

### TECHNICAL FIELD

The present disclosure relates to the technical field of network communications, and in particular, to a method for generating counting events and an electronic device.

### BACKGROUND

With the rapid development of Internet technologies, more and more tasks require user participation, especially, expect a user to express his/her viewpoint and opinion. However, the way in which a user may leave a message or make a comment is troublesome. Generally, a relatively simple way is to provide a simple interactive option for a user to make a choice, for example, a voting page dedicated to a certain topic may be set for a user to vote, or a button such as “Upvote”, “Downvote” and rating, etc., may be set on a news page or a video page, such that a user may express his/her opinion by just clicking a mouse or clicking on a screen. Additionally, on a video display interface, there is usually a count of the playing frequency of the video which may be considered as a disguised voting.

In the prior art, when there exists a need to creating a voting, corresponding codes must be developed, and a strong correlation exists between these codes and the system (for example, website or APP); in other words, the voting codes is tightly connected with the system codes, and it is difficult to modify the voting codes after they have been completed. At the same time, because there exist too many voting forms (in addition to conventional voting, there further exist disguised voting in various forms such as Upvote, rating, counting of the playing frequency mentioned above), their development is tedious and inefficient.

### SUMMARY

In order to overcome the current-existing drawbacks in the prior art, the disclosure provides a method for generating counting events and an electronic device, thereby solves the technical problem of low efficiency through developing a function, such as voting.

According to the first aspect of the embodiments of the disclosure, there provides a method for generating counting events, which includes:

storing preset counting rules, counting options and counting topics in a counting database, wherein a counting rule is corresponded to a counting rule identification, a counting option is corresponded to a counting option identification, and a counting topic is corresponded to a counting topic identification; among which, counting topics are correlated with subscribed contents;

acquiring a target counting event identification that includes a target counting rule identification, a target counting topic identification and a target counting option identification;

acquiring the corresponding target counting rule, target counting topic and target counting option from the counting database according to the target counting event identification; and

generating a target counting event according to the target counting rule, the target counting topic and the target counting option, wherein the target counting event is used for counting target counting options for the target counting topic sent by a user according to the target counting rule.

According to the second aspect of the embodiments of the disclosure, there further provides a non-transitory computer-readable storage medium for storing computer executable instructions, when executed by an electronic device, cause the electronic device to: store preset counting rules, counting options and counting topics in a counting database, wherein the counting rules are corresponded to counting rule identifications, the counting options are corresponded to counting option identifications, and the counting topics are corresponded to counting topic identifications; among which, the counting topics are correlated with subscribed contents; acquire a target counting event identification that comprises a target counting rule identification, a target counting topic identification and a target counting option identification; acquire a corresponding target counting rule, a corresponding target counting topic and a corresponding target counting option from the counting database according to the target counting event identification; and generate a target counting event according to the target counting rule, the target counting topic and the target counting option, wherein the target counting event is used for counting target counting options for the target counting topic sent by a user according to the target counting rule.

According to the third aspect of the embodiments of the disclosure, there further provides an electronic device including at least one processor and a memory communicably connected with the at least one processor for storing instructions executable by the at least one processor, wherein execution of the instructions by the at least one processor causes the at least one processor to: store preset counting rules, counting options and counting topics in a counting database, wherein the counting rules are corresponded to counting rule identifications, the counting options are corresponded to counting option identifications, and the counting topics are corresponded to counting topic identifications; among which, the counting topics are correlated with subscribed contents; acquire a target counting event identification that comprises a target counting rule identification, a target counting topic identification and a target counting option identification; acquire a corresponding target counting rule, a corresponding target counting topic and a corresponding target counting option from the counting database according to the target counting event identification; and generate a target counting event according to the target counting rule, the target counting topic and the target counting option, wherein the target counting event is used for counting target counting options for the target counting topic sent by a user according to the target counting rule.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for generating counting events according to an exemplary embodiment of the disclosure;

FIG. 2 is a flow chart of a method for generating counting events according to an exemplary embodiment of the disclosure;

FIG. 3 is a flow chart of a method for generating counting events according to an exemplary embodiment of the disclosure;

FIG. 4 is a flow chart of a method for generating counting events according to an exemplary embodiment of the disclosure;

FIG. 5 is a schematic diagram of a device for generating counting events according to an exemplary embodiment of the disclosure;

FIG. 6 is a schematic diagram of a device for generating counting events according to an exemplary embodiment of the disclosure;

FIG. 7 is a schematic diagram of a device for generating counting events according to an exemplary embodiment of the disclosure; and

FIG. 8 is a structural diagram of an electronic device according to one embodiment of the disclosure.

### DETAILED DESCRIPTION

Exemplary embodiments, of are illustratively shown in the drawings, will be described in detail hereinafter. When drawings are referred to, the same numeral in different drawings represents the same or similar element, unless otherwise mentioned. The implementation modes described in the following exemplary embodiments do not represent all the implementation modes consistent with the disclosure. Instead, they are merely examples of devices and methods being consistent with some aspects of the disclosure as described in detail in the claims appended.

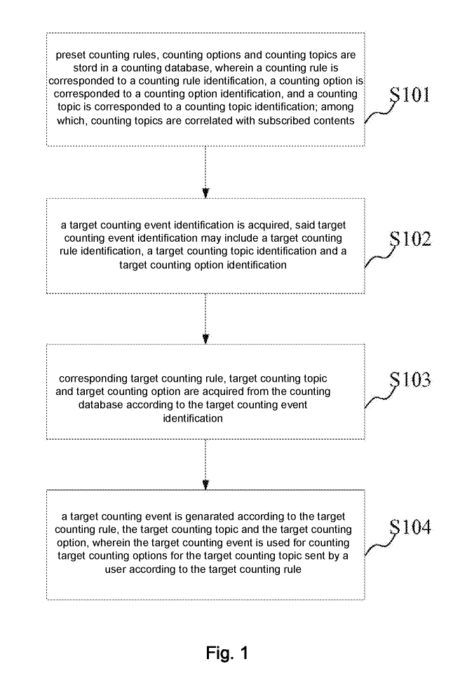

FIG. 1 is a flow chart of a method for generating counting events according to an exemplary embodiment. The method may be applied to, for example, a server, etc.

Referring to FIG. 1, the method may include:

In Step S101: preset counting rules, counting options and counting topics are stord in a counting database, wherein a counting rule is corresponded to a counting rule identification, a counting option is corresponded to a counting option identification, and a counting topic is corresponded to a counting topic identification; among which, counting topics are correlated with subscribed contents.

For example, the counting topic may be a voting on a problem. For convenience, the counting topic may be corresponded to an identification, or in other words, an identification will be assigned to the counting topic. Specifically, the identification may be an Identifier (ID), a serial number, etc. The content of the voting problem may be stored separately, and a correlation will be built up between the content and the counting topic.

In Step S102: a target counting event identification is acquired, said target counting event identification may include a target counting rule identification, a target counting topic identification and a target counting option identification;

The counting event identification (also called counting event ID) may be, for example, input by a technician.

As an example, count may be one of the following:

voting, Upvote, playing frequency, and rating.

When count is voting, the counting topic will be a voting topic, and the counting option will be a voting option.

When count is Upvote, the counting topic will be an upvote object, and the counting option will at least include one or both of Upvote and Downvote.

When count is playing frequency, the counting topic will be a play object, and the counting option will be playing once.

When the count is rating, the counting topic will be a rating object, and the counting option will include different scores.

Take voting as an example, according to the present disclosure, the voting content and the voting counting function may be made totally independent from each other, thereby realizing a decoupling. A voting is essentially a count of an identification (or in other words, a data quantity or an ID), and the containing data of the voting itself (for example, title, description, option content, etc.) are maintained by an invoking party; according to the present disclosure, it only needs to maintain a correlation between the voting event ID and the ballot.

During specific implementation, a voting event ID may be designed to have an A_B_C structure: A is a rule ID (i.e., counting rule identification), which may represent various rules; B is a topic ID (i.e., counting topic identification), and it may also be abstracted as an album ID, a video ID, etc., which may be set freely according to specific voting demands; C is an option ID (i.e., counting option identification), for example, it may represent voting for whom, and it may also be abstracted as Upvote and Downvote, etc. According to the disclosure, the specific form of ID/identification is not limited, for example, it may be alphabets and numbers, so long as a corresponding counting rule/counting topic/counting option represented by the identification may be queried according to the identification.

In Step S103: corresponding target counting rule, target counting topic and target counting option are acquired from the counting database according to the target counting event identification.

For example, the counting rule may include one or more of the following:

a prescription on whether login is required, a restriction on IP addresses, a prescription on an upper limit of user count, a restriction on user counting frequency, a prescription on counting valid time, a prescription on credit consumed by a count and a restriction on counting region.

In other words, a specific rule corresponded to the counting rule identification may be various combinations of the above rules.

In Step S104: a target counting event is generated according to the target counting rule, the target counting topic and the target counting option, wherein the target counting event is used for counting target counting options for the target counting topic sent by a user according to the target counting rule.

For example, if a counting event identification input by the technician is “12345_45678_5050”, the server may query the voting rule corresponded thereto as “voting after login” from a background database according to the “12345” therein, query the voting topic thereof as “which hot drama do you like best this week” from the background database according to “45678”, and query the voting option thereof as “1) Grave Robbery Note; 2) The Disguiser; 3) Nirvana in Fire” from the background database according to “5050”. Thereby, a counting event may be automatically created based on these three items, that is, a voting event for “Which hot drama do you like best this week” may be created. When a user sees the voting on a webpage, he may select a voting option on the webpage, thus the action of sending a target counting option to a server may be accomplished.

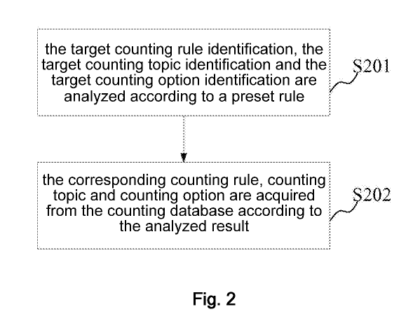

Referring to FIG. 2, in this embodiment or other embodiments of the disclosure, the step of acquiring corresponding target counting rule, target counting topic and target counting option from the counting database according to the target counting event identification may include:

In Step S201: the target counting rule identification, the target counting topic identification and the target counting option identification are analyzed according to a preset rule; and

In Step S202: the corresponding counting rule, counting topic and counting option are acquired from the counting database according to the analyzed result.

The identification is usually a certain symbol or a combination of symbols, which is abstractive and concise, and the meaning of an identification may only be known after it is analyzed according to a preset rule. The embodiments of the present disclosure are not limit how each identification and specific content of the preset rule are designed; instead, one skilled in the art may design these by himself according to different situations.

For example, a counting event identification input by the developer is “acef_452508_ZCL”, wherein “a” represents “login is required”, “c” represents “it can only be voted once”, “e” represents “no credit will be consumed”, and “f” represents “IP is restricted”, then a combined voting rule “login is required, it can only be voted once, no credit will be consumed, and IP is restricted” will be analyzed from “acef”; “Z” represents “Upvote”, “C” represents “Downvote”, and “L” represents “pass by”, then three options of a voting, “Upvote”, “Downvote” and “pass by”, will be analyzed from “ZCL”.

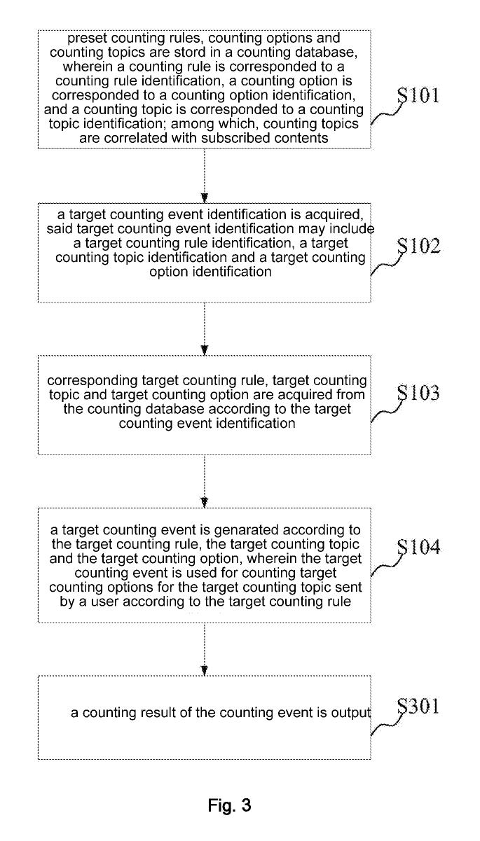

Additionally, referring to FIG. 3, in this embodiment or in other embodiments of the disclosure, the method may further include:

In Step S301: a counting result of the counting event is output.

For example, the background database may be Redis, and an ordered collection thereof may be used to store voting result data and calculate the ranking of the voting options in real time; if it is a registered voting (a user is required to log in, and the number of voting times for a single user is restricted, for example, each user can vote only once), an ordered collection may be used to store a voting behavior data of a user and calculate user ranking and the like in real time.

The technical solutions of the disclosure will be further described below in conjunction with specific scenes.

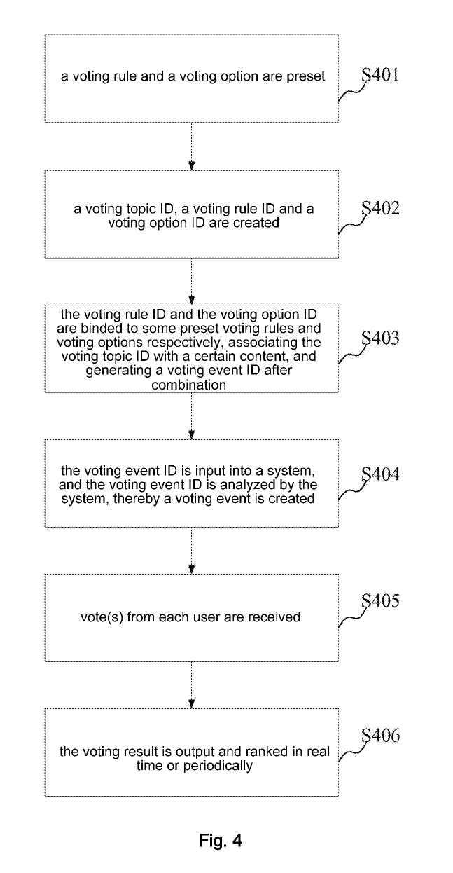

FIG. 4 is a flow chart of a method for creating counting information according to an exemplary embodiment, which includes:

In Step S401: a voting rule and a voting option are preset.

For example, a technician may preset various voting rules such as “login, IP restriction, number of voting times, frequency, upper limit, valid time, credit, region restriction”, etc.

In Step S402: a voting topic ID, a voting rule ID and a voting option ID are created.

For example, each ID may be randomly generated, or it may be designated by a technician at random, so long as it is unique and does no conflict with other IDs. For example, a voting topic ID may be “45678”, a voting rule ID may be “12345”, and a voting option ID may be “5050”.

In Step S403: the voting rule ID and the voting option ID are binded to some preset voting rules and voting options respectively, associating the voting topic ID with a certain content, and generating a voting event ID after combination.

For example, a voting event ID “12345_45678_5050”, i.e., a counting event identification, may be obtained by combining the three IDs.

In Step S404: the voting event ID is input into a system, and the voting event ID is analyzed by the system, thereby a voting event is created.

In Step S405: vote(s) from each user are received.

The system may be based on a Redis database and a Hypertext Preprocessor (PHP) operating environment, and an installation/deployment thereof may be accomplished with open source solutions. After deployment, a code package is deployed to a web folder, and it may come into effect with simple configuration.

Additionally, in order to cope with high traffic impact, an asynchronous queue mode may be employed, which may process 1000,000 voting operations per second asynchronously, and a background processing on a message queue may guarantee the ultimate consistency of the data.

In Step S406: the voting result is output and ranked in real time or periodically.

For example, a rank interface may be invoked to view the voting ranking, and a num interface may be invoked to view the result.

Since the voting system has been put into use, up to now, no additional development on the server end is required by any voting demand of an operator or a product personnel; moreover, more than 10 operation voting demands with different rule combinations are realized. The voting system may be configured for fulfilling demands of user Upvote, video (album) Upvote and Downvote, record of playing frequency, record of rating, videotext direct broadcast Upvote, etc., without any development work on the server end.

Additionally, one embodiment of the disclosure further provides a computer storage medium on which a program is stored, when executed, the program may perform a part or all of the steps in each implementation mode of the method for generating counting events according to the embodiments shown in FIG. 1-FIG. 4.

A device embodiment of the disclosure will be described below, which may be configured for executing the method embodiment of the disclosure. For the details not described in the device embodiment of the disclosure, reference may be made to the method embodiment of the disclosure.

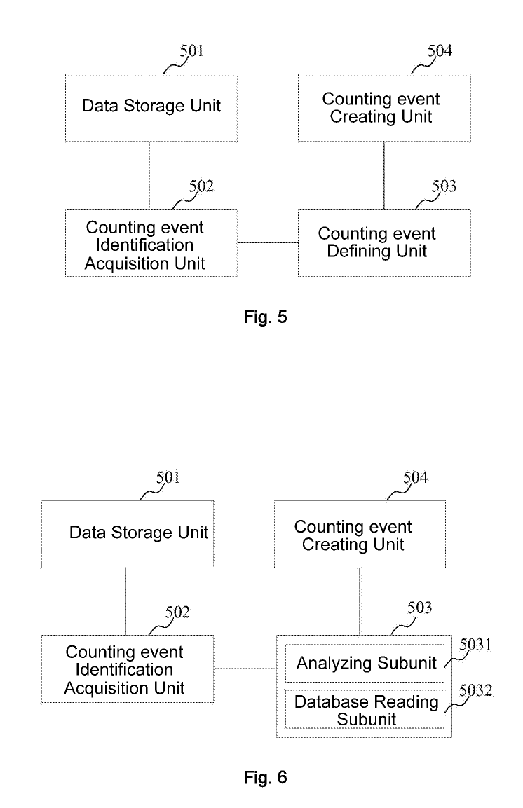

FIG. 5 is a schematic diagram of a device for generating counting events according to an exemplary embodiment. For example, the device may be applied to a server.

Referring to FIG. 5, the device may include:

a data storage unit 501, configured for storing a counting rule, a counting option and a counting topic, which are preset, in a counting database, wherein the counting rule is corresponded to a counting rule identification, the counting option is corresponded to a counting option identification, and the counting topic is corresponded to a counting topic identification, wherein, the counting topic is correlated with a subscribed content.

A counting event identification acquisition unit 502, configured for acquiring target counting event identification, which includes a target counting rule identification, a target counting topic identification and a target counting option identification.

For example, the counting event identification (also called counting event ID) may be input by a technician.

Take voting as an example, according to the present disclosure, the voting content and the voting counting function may be made totally independent from each other, thereby realizing a decoupling. A voting is essentially a count of an identification (or in other words, a data quantity or an ID), and the content data of the voting itself (for example, title, description, option content, etc.) are maintained by an invoking party; according to the present disclosure, it only needs to maintain a correlation between the voting event ID and the ballot.

During specific implementation, a voting event ID may be designed to have an A_B_C structure: A is a rule ID (i.e., counting rule identification), which may represent various rules; B is a topic ID (i.e., counting topic identification), and it may also be abstracted as an album ID, a video ID, etc., which may be set freely according to specific voting demands; C is an option ID (i.e., counting option identification), for example, it may represent voting for whom, and it may also be abstracted as Upvote and Downvote, etc. According to the disclosure, the specific form of ID/identification is not limited, for example, it may be alphabets and numbers, so long as a corresponding counting rule/counting topic/counting option represented by the identification may be queried according to the identification.

As an example, count may be one of the following:

voting, Upvote, playing frequency, and rating.

When count is voting, the counting topic will be a voting topic, and the counting option will be a voting option.

When count is Upvote, the counting topic will be an upvote object, and the counting option will at least include one or both of Upvote and Downvote.

When count is playing frequency, the counting topic will be a play object, and the counting option will be playing once.

When the count is rating, the counting topic will be a rating object, and the counting option will include different scores.

A counting event defining unit 503, configured for acquiring a corresponding target counting rule, target counting topic and target counting option from the counting database according to the target counting event identification.

For example, the counting rule may include one or more of the following:

a prescription on whether login is required, a restriction on IP addresses, a prescription on an upper limit of user count, a restriction on user counting frequency, a prescription on counting valid time, a prescription on credit consumed by a count and a restriction on counting region.

In other words, a specific rule corresponded to the counting rule identification may be various combinations of the above rules.

A counting event creating unit 504, configured for generating a target counting event according to the target counting rule, the target counting topic and the target counting option, wherein the target counting event is used for counting target counting options for the target counting topic sent by a user according to the target counting rule.

For example, if a counting event identification input by the technician is “12345_45678_5050”, the server may query the voting rule corresponded thereto as “voting after login” from a background database according to the “12345” therein, query the voting topic thereof as “which hot drama do you like best this week” from the background database according to “45678”, and query the voting option thereof as “1) Grave Robbery Note; 2) The Disguiser; 3) Nirvana in Fire” from the background database according to “5050”. Thereby, a counting event may be automatically created based on these three items, that is, a voting event for “Which hot drama do you like best this week” may be created. When a user sees the voting on a webpage, he may select a voting option on the webpage, thus the action of sending a target counting option to a server may be accomplished.

Referring to FIG. 6, in this embodiment or in other embodiments of the disclosure, the counting event defining unit 503 may include:

an analyzing subunit 5031, configured for analyzing the target counting rule identification, the target counting topic identification and the target counting option identification according to a preset rule; and

a database reading subunit 5032, configured for acquiring the corresponding counting rule, counting topic and counting option from the counting database according to the result analyzed.

For example, a counting event identification input by the developer is “acef_452508_ZCL”, wherein “a” represents “login is required”, “c” represents “it can only be voted once”, “e” represents “no credit will be consumed”, and “f” represents “IP is restricted”, then a combined voting rule “login is required, it can only be voted once, no credit will be consumed, and IP is restricted” will be analyzed from “acef”; “Z” represents “Upvote”, “C” represents “Downvote”, and “L” represents “pass by”, then three options of a voting, “Upvote”, “Downvote” and “pass by”, will be analyzed from “ZCL”.

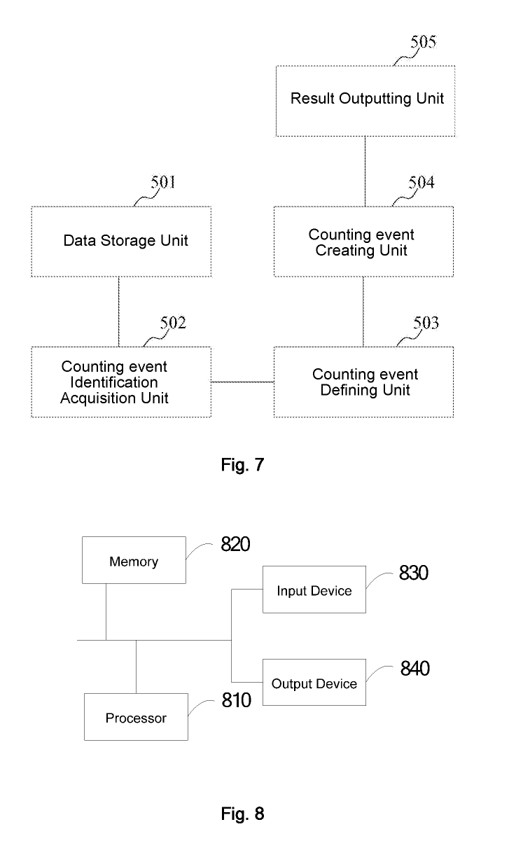

Additionally, Referring to FIG. 7, in this embodiment or in other embodiments of the disclosure, the device may further include:

a result outputting unit 505, configured for outputting a counting result of the counting event.

For example, the background database may be Redis, and an ordered collection thereof may be used to store voting result data and calculate the ranking of the voting options in real time; if it is a registered voting (a user is required to log in, and the number of voting times for a single user is restricted, for example, each user may vote only once), an ordered collection may be used to store a voting behavior data of a user and calculate user ranking and the like in real time.

For the device in the above embodiments, the specific mode in which each unit performs an operation has been described in detail in the related method embodiments, and will not be illustrated again in detail here.

The present disclosure provides a non-volatile computer storage medium for storing computer executable instructions, wherein the computer executable instructions may execute any one of the above methods for generating counting event according to the embodiments of present disclosure.

FIG. 8 is a diagram illustrating a hardware structure of an electronic device which can execute the method for generating counting event provided by an embodiment of the disclosure. As shown in FIG. 8, the electronic device includes:

at least one processor 810 and a memory 820, wherein only one processor 810 is illustratively shown in FIG. 8.

The device executing the method for generating counting event may also include: an input device 830 and an output device 840.

The processor 810, memory 820, input device 830 and output device 840 may be connected via a bus or other means, wherein a connecting bus is illustratively shown in FIG. 8.

The memory 820, as a non-volatile computer readable storage medium, may be used to store non-volatile software programs, non-volatile computer executable programs and modules, such as the program instructions/modules corresponded to the method for generating counting event according to the embodiments in the present disclosure (for example, the data storage unit 501, counting event identification acquisition unit 502, counting event defining unit 503 and counting event creating unit 504 illustrated in FIG. 5). The processor 810, by running non-volatile software programs, instructions and modules stored in the memory 820, performs various functional applications and data processing of the server, i.e., carries out the method for generating counting event according to the above embodiments in the present disclosure.

The memory 820 may include a program storage area and a data storage area, wherein the program storage area may be used to store application programs needed by an operating system or by at least one function, and the data storage area may be used to store data created by running the device for generating counting events, and the like. Moreover, the memory 820 may include a high speed random access memory, and also may include a non-volatile memory, such as at least one disk memory, flash memory, or other non-volatile solid state memory. According to some embodiments, the memory 820 may optionally include memories that are remotely setup with respect to the processor 810, and these remote memories may be connected to the device for generating counting events via a network connection. An example of such a network includes, but not limited to, internet, intranet, local area network, mobile communication network, and a combination thereof.

The input device 830 may receive input digital or character information, and generate key signal inputs concerned with user setting and functional control of the device for generating counting events. The output device 840 may include displaying means such as a display screen.

The at least one module is stored in the memory 820, and, when run by the at least one processor 810, executes the method for generating counting event according to any one of the above method embodiments.

The above product may excite the method provided by the embodiments of the present disclosure, and has functional modules and beneficial effects corresponded to the executed method. As for technical details that are not elaborated in the present embodiments, reference can be made to the method provided by the embodiments of the present disclosure.

The electronic devices in the embodiments of the present disclosure exists in various forms, including but not limited to:

(1) mobile communication devices, characterized in having a function of mobile communication mainly aimed at providing speech and data communication, wherein such terminal includes: smart phone (such as iPhone), multimedia phone, functional phone, low end phone and the like;

(2) ultra mobile personal computer devices, which falls in a scope of personal computer, has functions of calculation and processing, and generally has characteristics of mobile internet access, wherein such terminal includes: PDA, MID and UMPC devices, such as iPad;

(3) portable entertainment devices, which can display and play multimedia contents, and includes audio or video player (such as iPod), portable game console, E-book and intelligent toys and portable vehicle navigation devices;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the apparatus are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer apparatus (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for generating a counting event, comprising:
at an electronic device,
storing preset counting rules, counting options and counting topics in a counting database, wherein the counting rules are corresponded to counting rule identifications, the counting options are corresponded to counting option identifications, and the counting topics are corresponded to counting topic identifications; among which, the counting topics are correlated with subscribed contents;
acquiring a target counting event identification that comprises a target counting rule identification, a target counting topic identification and a target counting option identification;
acquiring a corresponding target counting rule, a corresponding target counting topic and a corresponding target counting option from the counting database according to the target counting event identification; and
generating a target counting event according to the target counting rule, the target counting topic and the target counting option, wherein the target counting event is used for counting the target counting option for the target counting topic sent by a user according to the target counting rule.

2. The method according to claim 1, wherein acquiring the corresponding target counting rule, target counting topic and target counting option from the counting database according to the target counting event identification comprises:
analyzing the target counting rule identification, the target counting topic identification and the target counting option identification according to a preset rule; and
acquiring a corresponding counting rule, a corresponding counting topic and a corresponding counting option from the counting database according to the analyzed result.

3. The method according to claim 1, wherein
the counting topic is a voting topic, and the counting option is a voting option; or
the counting topic is an upvote object, and the counting option at least comprises one or both of Upvote and Downvote; or
the counting topic is a play object, and the counting option is playing once; or
the counting topic is a rating object, and the counting option comprises different scores.

4. The method according to claim 1, wherein the counting rule comprises one or more of:
a prescription on whether login is required, a restriction on IP address, a prescription on upper limit of user count, a restriction on user counting frequency, a prescription on counting valid time, a prescription on credit consumed by a count and a restriction on counting region.

5. The method according to claim 1, further comprising:
outputting a counting result of the counting event.

6. A non-transitory computer-readable storage medium storing executable instructions that, when executed by an electronic device, cause the electronic device to:
store preset counting rules, counting options and counting topics in a counting database, wherein the counting rules are corresponded to counting rule identifications, the counting options are corresponded to counting option identifications, and the counting topics are corresponded to counting topic identifications; among which, the counting topics are correlated with subscribed contents;
acquire a target counting event identification that comprises a target counting rule identification, a target counting topic identification and a target counting option identification;
acquire a corresponding target counting rule, a corresponding target counting topic and a corresponding target counting option from the counting database according to the target counting event identification; and
generate a target counting event according to the target counting rule, the target counting topic and the target counting option, wherein the target counting event is used for counting target counting options for the target counting topic sent by a user according to the target counting rule.

7. The non-transitory computer-readable storage medium according to claim 6, wherein the step to acquire the corresponding target counting rule, target counting topic and target counting option from the counting database according to the target counting event identification comprises:
analyzing the target counting rule identification, the target counting topic identification and the target counting option identification according to a preset rule; and
acquiring a corresponding counting rule, counting topic and counting option from the counting database according to the analyzed result.

8. The non-transitory computer-readable storage medium according to claim 6, wherein:
the counting topic is a voting topic, and the counting option is a voting option; or
the counting topic is an upvote object, and the counting option at least comprises one or both of Upvote and Downvote; or
the counting topic is a play object, and the counting option is playing once; or
the counting topic is a rating object, and the counting option comprises different scores.

9. The non-transitory computer-readable storage medium according to claim 6, wherein the counting rule comprises one or more of:
a prescription on whether login is required, a restriction on IP address, a prescription on upper limit of user count, a restriction on user counting frequency, a prescription on counting valid time, a prescription on credit consumed by a count and a restriction on counting region.

10. The non-transitory computer-readable storage medium according to claim 6, wherein the executable instructions further cause the electronic device to
output a counting result of the counting event.

11. An electronic device, comprising:
at least one processor; and
a memory communicably connected with the at least one processor for storing instructions executable by the at least one processor, wherein execution of the instructions by the at least one processor causes the at least one processor to:
store preset counting rules, counting options and counting topics in a counting database, wherein the counting rules are corresponded to counting rule identifications, the counting options are corresponded to counting option identifications, and the counting topics are corresponded to counting topic identifications; among which, the counting topics are correlated with subscribed contents;
acquire a target counting event identification that comprises a target counting rule identification, a target counting topic identification and a target counting option identification;
acquire a corresponding target counting rule, a corresponding target counting topic and a corresponding target counting option from the counting database according to the target counting event identification; and
generate a target counting event according to the target counting rule, the target counting topic and the target counting option, wherein the target counting event is used for counting target counting options for the target counting topic sent by a user according to the target counting rule.

12. The electronic device according to claim 11, wherein the step to acquire the corresponding target counting rule, target counting topic and target counting option from the counting database according to the target counting event identification comprises:
analyzing the target counting rule identification, the target counting topic identification and the target counting option identification according to a preset rule; and
acquiring a corresponding counting rule, counting topic and counting option from the counting database according to the analyzed result.

13. The electronic device according to claim 11, wherein
the counting topic is a voting topic, and the counting option is a voting option; or
the counting topic is an upvote object, and the counting option at least comprises one or both of Upvote and Downvote; or
the counting topic is a play object, and the counting option is playing once; or
the counting topic is a rating object, and the counting option comprises different scores.

14. The electronic device according to claim 11, wherein the counting rule comprises one or more of:
a prescription on whether login is required, a restriction on IP address, a prescription on upper limit of user count, a restriction on user counting frequency, a prescription on counting valid time, a prescription on credit consumed by a count and a restriction on counting region.

15. The electronic device according to claim 11, wherein the executable instructions further cause the electronic device to
output a counting result of the counting event.
